(19) United States
(12) Patent Application Publication
(10) Pub. No.: US 2007/0273119 A1
(43) Pub. Date: Nov. 29, 2007

(54) Steering arm

(75) Inventor: Lucas Stoia, Taylors, SC (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/439,709

(22) Filed: May 24, 2006

(51) Int. Cl. B62D 7/18

(52) U.S. Cl. 280/93.512

(57) ABSTRACT

A steering arm includes a curved center portion having a recessed area where the curved center portion is defined by a non-symmetrical cross-section. The non-symmetrical cross-section comprises an I-section having first and second portions interconnected by a third portion. The first portion has a greater cross-sectional area than the second portion.

### TECHNICAL FIELD

The subject invention relates to a reduced weight steering arm for a vehicle steering system that has an I-shaped cross-section that is formed to reduce material stock size required for forging while maintaining original strength of the component.

### BACKGROUND OF THE INVENTION

A steering arm is used to transmit a steering input from a steering linkage to a vehicle wheel. The steering linkage is comprised of various components, such as a pitman arm, drag link, etc., and is actuated by a steering wheel. One end of the steering arm is connected to a steering knuckle at the vehicle wheel, and an opposite end of the steering arm is connected to the drag link with a ball stud. The steering arm is used to convert a drag link force into a turning moment about a king pin installed within the steering knuckle. The steering arm is subjected to high concentrations of stress during turning maneuvers and is a critical component within a vehicle steering system. Thus, the steering arm must be very robust.

A steering arm is typically formed in a hook-shape and includes a curved arm portion that extends between the ends of the steering arm. In the past, this curved arm portion has been defined by a trapezoidal cross-sectional shape, shown generally at 10 in prior art FIG. 1. The load of the steering arm is applied through a center of the ball stud at the drag link, which presents an offset load. The cross-section of 10 in the prior art is not oriented or “clocked” optimally to meet this offset loading, thus further reducing the effectiveness of the prior art configuration.

Further, these traditional hook style steering arms use excessive material to ensure a robust design. With recent significant increases in steel prices, a solution is required to reduce the amount of material required to make the steering arm without adversely affecting stress characteristics of the steering arm.

### SUMMARY OF THE INVENTION

A steering arm includes a curved center portion that is defined by a non-symmetrical cross-sectional area. The non-symmetrical cross-sectional area comprises an I-shaped section. The I-shaped section includes a first portion, a second portion, and a third portion that connects the first and second portions. The third portion extends transversely to the first and second portions to form an I-shape. The curved center portion is defined by an outer radius and an inner radius. The first portion of the I-shaped section has a larger cross-sectional area than the second portion, and the first portion is formed along the inner radius of the curved center portion.

This cross-sectional configuration significantly reduces the amount of material required to form the steering arm, which provides a more cost effective design. Further, the I-shaped section will experience equivalent stress as compared to prior trapezoidal designs under maximum loading conditions.

These and other features of the present invention can be best understood from the following specification and drawings, the following of which is a brief description.

### BRIEF DESCRIPTION OF THE DRAWINGS

FIG. 1 is a cross-sectional view of a steering arm designed according to the prior art.

FIG. 2A is a perspective view of a knuckle and steering arm assembly incorporating the subject invention.

FIG. 2B is a top view of FIG. 2A.

FIG. 3 is a cross-sectional view of one embodiment of a steering arm incorporating the subject invention.

FIG. 4 is a cross-sectional view of another embodiment of a steering arm incorporating the subject invention.

### DETAILED DESCRIPTION OF THE PREFERRED EMBODIMENT

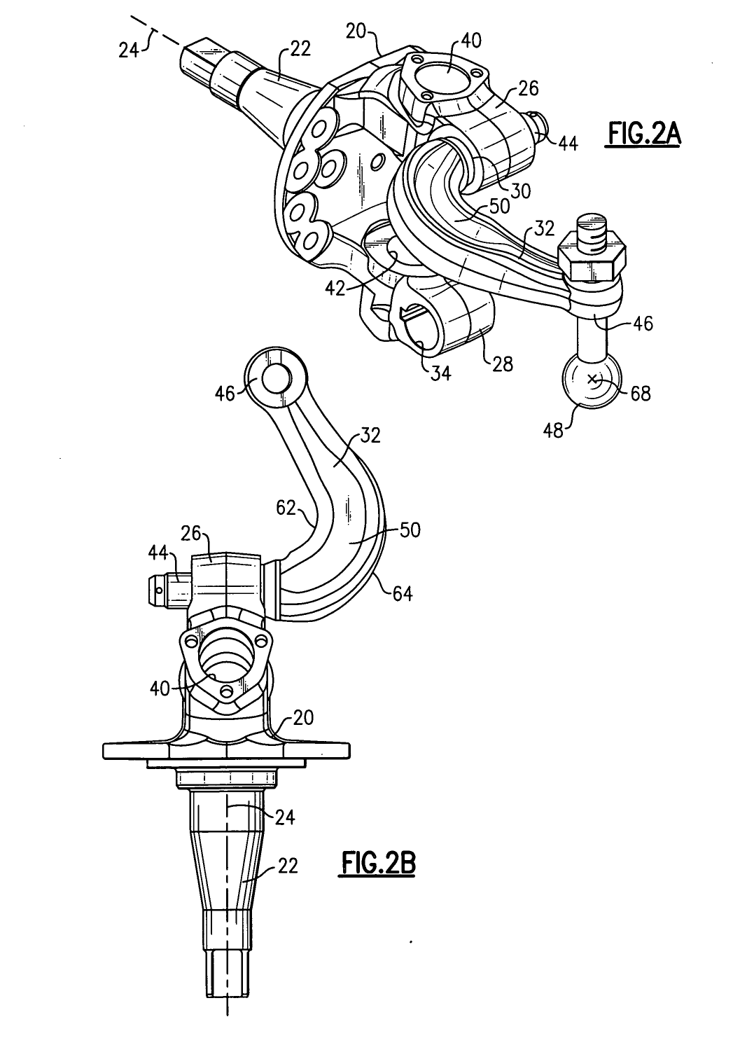

FIGS. 2A and 2B show a knuckle 20 for a vehicle wheel assembly (not shown). The knuckle 20 includes a spindle 22 that supports a vehicle wheel assembly for rotation about an axis 24. The knuckle 20 includes an upper boss portion 26 and a lower boss portion 28. The upper boss portion 26 includes a steering arm bore 30 that receives a steering arm 32. The lower boss portion 28 includes a tie rod arm bore 34 that receives a tie rod arm (not shown).

The upper boss portion 26 includes an upper bore 40 and the lower boss portion 28 includes a lower bore 42. A king pin (not shown) is inserted through the upper 40 and lower 42 bores as known. The upper 40 and lower 42 bores extend in a generally vertical direction, while the steering arm 30 and tie rod arm 34 bores extend in a generally horizontal direction.

The steering arm 32 includes a first end 44 that is connected to the knuckle 20 at the steering arm bore 30 and a second end 46 that is connected to a drag link (not shown) with a ball stud 48. A curved center portion 50 extends between the first end 44 and the second end 46. The curved center portion 50 forms a hook or C-shape.

The steering arm 32 is used to convert a drag link force into a turning moment about the king pin installed within the knuckle 20. The drag link is part of a steering linkage system that is actuated by a steering wheel (not shown). When the steering wheel is rotated, the steering linkage assembly rotates the knuckle 20 via the steering arm 32. The tie rod arm is connected to a tie rod (not shown), which is used to transmit turning input to an opposite, laterally spaced, vehicle wheel assembly as known.

During turning maneuvers, the steering arm 32 is subjected to high steering input loads, which can result in high stresses within the steering arm. In order to reduce stress concentration levels within the steering arm 32, the curved center portion has been configured with a non-symmetrical cross-section having an I-shape 52, as shown in FIG. 3. Utilizing finite element analysis (FEA) and curved beam theory, it was found that an optimized unsymmetric I-shaped cross-section with equal cross-sectional area will have less stress than cross-section 10 of the prior art configuration, or at some reduced cross-sectional area will have equivalent stress under equivalent bending loads.

The I-shape 52 includes a first portion 54, a second portion 56, and a third portion 58 that connects the first 54 and second 56 portions. The first 54 and second 56 portions are generally parallel to each other with the third portion 58 extending transversely to the first 54 and second 56 portions. Preferably, the third portion 58 is perpendicular to the first 54 and second 56 portions to form the I-shape 52.

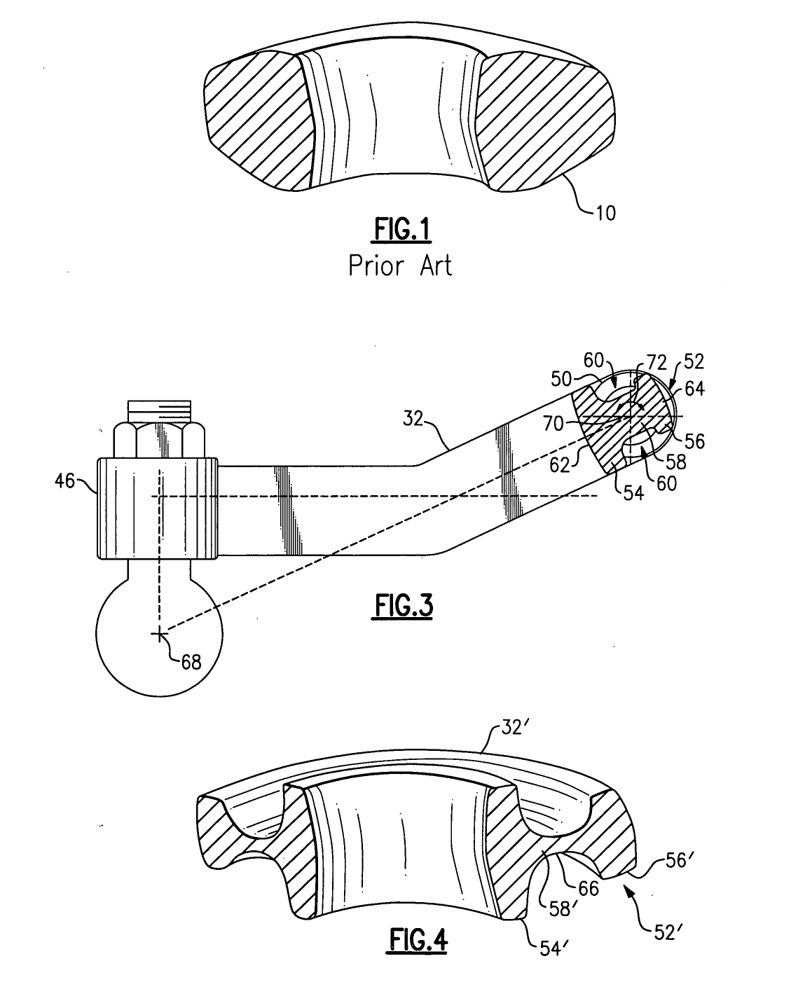

This I-shape 52 provides recessed areas 60 on opposing sides of the steering arm 32. The recessed areas 60 extend along the third portion 58 between the first 54 and second 56 portions, and extend along the length of the curved center portion 50. This steering arm configuration requires significantly less material to produce than prior designs such as that shown in FIG. 1. This provides reduced weight and is a more cost effective design.

FIG. 4 shows another embodiment of an I-shape 52′. In this configuration, a third portion 58′ is narrower than the third portion 58 of the embodiment shown in FIG. 3. The third portion 58′ includes a significantly curved surface 66 that transitions from a first portion 54′ to a second portion 56′. This configuration further reduces the amount of material required to make the steering arm 32′ without adversely affecting stress characteristics.

As shown in FIG. 2B, the curved center portion 50 is defined by an inner radius portion 62 and an outer radius portion 64. As discussed above, the I-shape 52 (FIG. 3) has the first portion 54, second portion 56, and third portion 58 that connects the first 54 and second 56 portions. The first portion 54 has a greater cross-sectional area than the second portion 56, and is formed along the inner radius portion 62. Having the first portion 54, with the greater cross-sectional area, formed along the inner radius portion 62, significantly reduces stress concentration levels.

Clocking the I-shaped cross-section to maintain a desired relationship with the ball stud 48 also reduces stress levels. When installed within the steering arm 32, the ball stud 48 defines a ball center 68 (FIG. 2A). In the example shown, the installation position is referred to as a “ball down” position. The ball stud 48 could also be installed in a “ball up” position, however, the subject steering arm 32 would need to be reconfigured by clocking the I-section appropriately to retain the relationship between the section and ball stud center as shown in FIG. 3.

The ball center 68 is typically always in the same position in relationship to the second end 46 of the steering arm 32. However,

the length and drop of the steering arm 32 can be varied depending upon vehicle application. The I-shaped section is clocked in such a way to orient the section to meet the offset load applied to the steering arm 32 via the balls stud 48 and drag link.

As shown in FIG. 3, the I-shape 52 defines a section center 70 of the cross-sectional area. The section center 70 extends along a length of the curved center portion 50. The I-shape 52 can be clocked or rotated about this center section 70, as indicated by arrow 72, to orient the cross-section in a desired location. The degree or amount of rotation or clocking will vary depending upon vehicle application.

The subject invention provides a steering arm 32 with equivalent stress characteristics and reduced weight. This provides a robust and cost effective design.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A steering arm comprising:
a steering arm body having a curved center portion with at least one recessed area, said curved center portion being defined by a non-symmetrical cross-section.

2. The steering arm according to claim 1 wherein said non-symmetrical cross-section is shaped as an I-section.

3. The steering arm according to claim 2 wherein said I-section comprises first and second portions connected together with a third portion extending transversely to said first and said second portions, and wherein said at least one recessed area is formed along said third portion between said first and said second portions.

4. The steering arm according to claim 3 wherein said first portion has a greater cross-sectional area than said second portion.

5. The steering arm according to claim 4 wherein said curved center portion is defined by an outer radius portion and an inner radius portion, and wherein said first portion of said I-section is formed along said inner radius portion.

6. The steering arm according to claim 4 wherein said first and said second portions are generally parallel to each other with said third portion being perpendicular to said first and said second portions.

7. The steering arm according to claim 1 wherein said steering arm body includes a first end adapted for connection to a steering knuckle and a second end adapted for connection to a drag link with a ball stud, said curved center portion extending between said first and said second ends.

8. A steering knuckle assembly comprising:
a knuckle having a spindle portion; and
a steering arm having a first end mounted to said knuckle, a second end adapted to receive a ball stud, and a curved center portion extending between said first and said second ends, said curved center portion being defined by an I-shaped section.

9. The steering knuckle assembly according to claim 8 wherein said curved center portion comprises a C-shape.

10. The steering knuckle assembly according to claim 8 wherein said I-shaped section includes first and second portions connected together with a third portion extending transversely to said first and said second portions, said first portion having a greater cross-sectional area than said second portion.

11. The steering knuckle assembly according to claim 10 wherein said curved center portion is defined by an outer radius portion and an inner radius portion, and wherein said first portion of said I-shaped section is formed along said inner radius portion.

12. The steering knuckle assembly according to claim 11 wherein said ball stud defines a ball center and wherein said non-symmetrical cross-section is clocked to a desired position by rotating said first and second portions of said I-section about a section center of said I-shaped section to maintain a desired relationship between the ball center and said I-shaped cross-section.

13. The steering knuckle assembly according to claim 11 wherein said first and said second portions are generally parallel to each other with said third portion being perpendicular to said first and said second portions.
